(19) United States
(12) Patent Application Publication
(10) Pub. No.: US 2025/0081230 A1
(43) Pub. Date: Mar. 6, 2025

(54) METHOD AND SYSTEM FOR A WIRELESS DEVICE TO SWITCH TO A NON-PRIMARY CHANNEL ACCESS (NPCA) PRIMARY CHANNEL TO TRANSMIT FRAMES TO ANOTHER WIRELESS DEVICE

(71) Applicant: NXP USA, Inc., AUSTIN, TX (US)

(72) Inventors: Liwen Chu, San Ramon, CA (US); Rui Cao, Sunnyvale, CA (US); Kiseon Ryu, San Diego, CA (US); Huizhao Wang, San Jose, CA (US); Hongyuan Zhang, Fremont, CA (US)

(21) Appl. No.: 18/820,607

(22) Filed: Aug. 30, 2024

Related U.S. Application Data
(60) Provisional application No. 63/580,139, filed on Sep. 1, 2023.
(60) Provisional application No. 63/643,301, filed on May 6, 2024.

(51) Int. Cl. H04W 74/08

(52) U.S. Cl. CPC H04W 74/08

(57) ABSTRACT

A method and system for announcing, by a first wireless device, one or more non-primary channel access (NPCA) primary channels of a basic service set (BSS) operating channel for frame transmission. A determination is made that the primary channel is busy and switching to a NPCA primary channel in response to the primary channel being busy and overlapping BSS activity. A frame is transmitted over the NPCA primary channel to a wireless device based on a backoff counter of the NPCA primary channel reaching a predefined value, the backoff counter set based on an enhanced distributed channel access (EDCA) parameter set.

### RELATED APPLICATION

This application claims a benefit of priority to U.S. Provisional Application No. 63/643,301 entitled “Secondary Channel Usage” filed May 6, 2024 and U.S. Provisional Application No. 63/580,139 entitled “Backoff and TXOP BW in wide BW BSS” filed Sep. 1, 2023, the contents each of which are incorporated herein by reference in their entireties.

### FIELD OF USE

This disclosure generally relates to wireless communication, and more particularly to a method and system for a wireless device to switch to a non-primacy channel access (NPCA) primary channel to transmit frames to another wireless device.

### BACKGROUND

In wireless communications defined by Institute of Electrical and Electronics Engineers (IEEE) 802.11, a wireless device transmits one frame or multiple frames in a transmit opportunity (TXOP). The TXOP is an interval of time duration which a particular access point and client station have the right to initiate frame exchange sequences onto a wireless medium. A basic service set (BSS) includes a plurality of wireless devices such an access point (AP) and one or more client stations (STAs) which communicate with the AP. During the TXOP, a wireless device exchanges frames with another wireless device in the BSS.

A BSS operating channel includes more than one backoff channel, i.e. primary backoff channel and a plurality of non-primary channel access (NPCA) primary channels (secondary backoff channel), with each backoff channel is related to a backoff procedure. Each backoff channel is a 20 MHz channel. Further the BSS operating channel can be divided into a multiple 20 MHz channels which are grouped into a plurality of subchannels with each subchannel has a backoff channel. Each subchannel covered by the BSS operating channel includes multiple 20 MHz channels, e.g. a subchannel with 80 MHz bandwidth is defined as a 80 MHz subchannel. To transmit a frame, a backoff procedure related to the primary channel or the plurality of NPCA primary channels is executed.

### BRIEF DESCRIPTION OF THE DRAWINGS

The drawings are for the purpose of illustrating example embodiments, but it is understood that the embodiments are not limited to the arrangements and instrumentality shown in the drawings.

FIG. 1 depicts an example wireless network in accordance with one or more embodiments.

FIG. 2 illustrates various conditions during which an access point (AP) and client station (STA) switches to a NPCA primary channel in accordance with one or more embodiments.

FIG. 3 illustrates example announcements by the STA to use a NPCA primary channel for frame reception in accordance with one or more embodiments.

FIG. 4 illustrates various usage of channel combinations in a BSS operating channel in accordance with one or more embodiments.

FIG. 5 illustrates various parameter settings of the NPCA primary channel in accordance with one or more embodiments.

FIG. 6 illustrates example functions for determining a clear channel assessment (CCA) level for whether the NPCA primary channel and secondary channels are busy or idle in accordance with one or more embodiments.

FIG. 7 illustrates various parameter settings when switching from the NPCA primary channel to a primary channel in accordance with one or more embodiments.

FIG. 8 illustrates an example flow chart of functions associated with switching to the NPCA primary channel when the primary channel is busy in accordance with one or more embodiments.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

One or more embodiments disclosed herein are directed to a method and system for a wireless device to perform a backoff in transmitting frames to another wireless device when the wireless devices are in a same basic service set (BSS). An access point (AP) announces a primary channel and one NPCA primary channel of a basic service set (BSS) operating channel with multiple 20 MHz channels for the AP and its associated STAs to do the frame exchanges through the enhanced distributed channel access (EDCA) procedure restricted by an announced EDCA parameter set. The wireless device (AP or its associated STA) initially attempts to transmit the frame(s) of an access category (AC) over a primary channel of the wireless device. If the primary channel is busy, the wireless device then switches to the NPCA primary channel based on overlapping BSS activity. In order to transmit the frame(s) of the AC, the backoff counter for the AC in the NPCA primary channel is started based on the announced EDCA parameters. The backoff counter of the AC for the NPCA primary channel is counted down over time if the NPCA primary channel is idle. When a counter value of the backoff counter reaches a predefined value, the wireless device transmits the frame in the NPCA primary channel and the other secondary channels that are idle. The usage of the NPCA primary channel for the frame exchanges ends when the primary channel is idle. Well known instructions, protocols, structures, and techniques have not been shown in detail in order not to obfuscate the description.

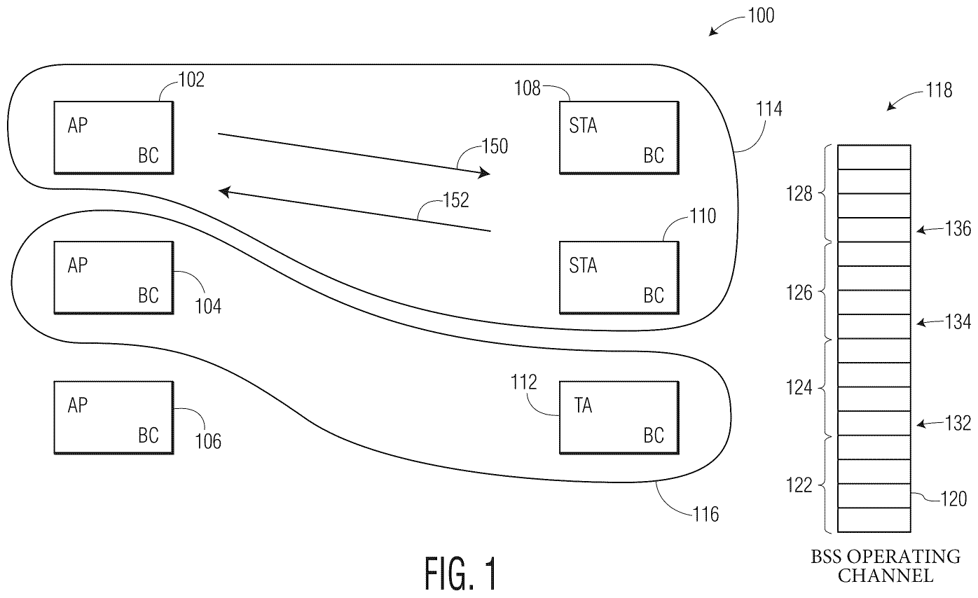

FIG. 1 depicts an example wireless network 100 in accordance with one or more embodiments. The wireless system 100 includes one or more wireless devices such as one or more access points (APs) 102-106 and one or more client stations (STAs or non-AP STAs) 108-112 that operate based on the Institute of Electrical and Electronics Engineers (IEEE) 802.11 standard. For example, the wireless system 100 may be compatible with IEEE 802.11 such as IEEE 802.11ac, IEEE 802.11ax, IEEE 802.11be, and IEEE 802.11bn. IEEE 802.11ac is referred to as a very high throughput (VHT). IEEE 802.11ax is referred to as high efficiency (HE). IEEE 802.11be is referred to as extreme high throughput (EHT). IEEE 802.11bn is referred to as ultra-high reliability (UHR). The wireless system 100 may have fewer or more APs or STAs than as illustrated. The STA may be an end device which wirelessly communicates with an AP while the AP may facilitate connections by nearby associated devices such as STAs to a wired network such as the Internet. The AP, STA and associated components and functions described herein may be implemented with circuitry such as one or more of analog circuitry, mix signal circuitry, memory circuitry, logic circuitry, and processing circuitry that executes code stored in a memory that when executed by the processing circuitry performs the disclosed functions.

A basic service set (BSS) is defined by an association process of IEEE 802.11 and is a network topology which includes an AP and one or more STA associated with the AP. In one or more examples, AP 102 and STA 108-110 may be associated with and define a BSS 114 and AP 104 and STA 112 may be associated and define another BSS 116. BSS information of the BSS may include capabilities and operating parameters of the BSS set up by an AP of the BSS such as one or more of a BSS operating channel and a BSS identification (BSSID). The BSS operating channel may be a bandwidth of the BSS divided into a multiple channels which includes multiple backoff channels (e.g. the primary channel and one or more non-primary channel access (NPCA) primary channel). The NPCA primary channel is a secondary channel of the BSS operating channel to use when the primary channel is busy. NPCA is developed by the IEEE 802.11 to improve bandwidth utilization by optimizing the use of secondary channels. The BSS operating channel may also be grouped into a plurality of subchannels with each subchannel including a backoff channel. An example BSS operating channel of a BSS is shown as a BSS operating channel 118 of BSS 114 which has a plurality of 20 MHz channels, an example which is shown as channel 120. Each channel may be 20 MHz channel and each subchannel 122-128 includes four 20 MHz channels to define an respective 80 MHz subchannel. The BSS operating channel 118 may span a bandwidth of 320 MHz in this example. In one or more examples, the BSS operating channel may span a bandwidth of 160 MHz or 80 MHz with a corresponding number of 20 MHz channels.

One of the subchannels may be referred to as a primary subchannel and the remainder of the subchannels may be secondary subchannels or non-primary subchannels. The primary subchannel includes a primary channel used to do the backoff for the frame exchanges on a primary channel and the other secondary channels where the other secondary channels can be the secondary channels of the primary subchannel and the other subchannels. In one or more examples, subchannel 122 may be a primary subchannel having a primary channel and remaining channels in the subchannels 124-128 may be secondary subchannels where each has a non-primary channel access (NPCA) primary channel. To transmit a frame of an access category (AC), a determination is made whether the primary channel in the primary subchannel is idle or busy. Each wireless device maintains a backoff counter (BC) for each AC associated with the primary channel. The backoff counter is decremented over time from a starting value if the primary channel is idle. When a count value of the backoff counter reaches the predefined value, the wireless device transmits the frame in the primary channel and the other secondary channels that are idle based on a clear channel assessment (CCA) of the secondary channel. The primary channel is idle or busy depending on whether interference is detected from an overlapping BSS (OBSS) in the primary channel or the other device's frame exchanges in the BSS. For example, BSS 116 may be an OBBS to BSS 114 and generate interference in BSS 114. If the primary channel is busy because of the OBSS frame exchanges or the other activity on the primary channel, then device may not switch to the NPCA primary channel to do the frame exchanges until the primary channel becomes idle again.

In one or more embodiments, when a device determines that a primary channel is busy, instead of staying on the primary channel to wait for the idle primary channel again the device switches to the NPCA primary channel and tries to use the NPCA primary channel and the other idle secondary channels to do the frame exchanges until the primary channel becomes idle again. The NPCA primary channel is one of the secondary (=non-primary) channels and sometimes referred to as the non-primary channel access (NPCA) primary channel of the BSS operating channel 118. In one or more examples, the AP announces in a management frame 150 such as a beacon frame or probe response frame a primary channel and one or more NPCA primary channels. In one or more examples, the AP only announces in a management frame 150 such as a beacon frame or probe response frame one NPCA primary channel. In one or more examples, the AP also announces in a management frame 150 such as a beacon frame or probe response frame the condition that a device switches to a NPCA primary channel. The condition may be based on a OBSS activity such as an OBSS TXOP duration or OBSS PPDU length. If the OBSS TXOP duration or OBSS PPDU length is longer than a threshold, a device switches to a NPCA primary channel. In one or more examples, all APs of a multiple BSSID set (or all APs of a co-hosted AP set) announces the same NPCA primary channels on their BSS operating channel. In one or more examples, the AP may only announce one NPCA primary channel besides the primary channel. In one or more examples, an AP without multiple BSSID support (or all the APs of a multiple BSSID set, or all APs of a co-hosted AP set) can only announce one same NPCA primary channel besides the primary channel. In some examples, an AP without multiple BSSID support (or all the APs of a multiple BSSID set, or all APs of a co-hosted AP set) announce the same condition that a device switches to a NPCA primary channel after detecting the primary channel is busy. In some embodiments, such condition is the length threshold of the OBSS TXOP or OBSS PPDU. In the BSS operating channel 118, secondary channels 132-136 may each be NPCA primary channels in one or more examples. In some embodiments, the backoff in the primary channel and the backoff in NPCA primary channel use the parameters from the same EDCA Parameter set. In some embodiments, the AP may announce various enhanced distributed channel access (EDCA) parameters for the NPCA primary channels to facilitate determining by the STA whether to use the NPCA primary channel for frame transmission when the primary channel is busy. The NPCA primary channel may be used to transmit frames in a TXOP of the BSS 114. If the primary channel is busy, the wireless device switches to a NPCA primary channel and the frames are transmitted in the NPCA primary channel. In one or more examples, the STA announces by an announcement 152 whether it supports switch to a NPCA primary channel and whether it enables the NPCA primary channel switch. In some examples, an STA announces by an announcement 152 whether it supports a NPCA primary channel switch (=secondary channel usage) or channel combination of decoding a PPDU on a primary channel and secondary channel simultaneously. Further, the STA will define its operating channel bandwidth in a way that covers or parks on the NPCA primary channel and secondary channels when switching to the NPCA primary channel from the primary channel. In some embodiments, the parking on one NPCA primary channel and the secondary channels is in line with the channelization. A 80 MHz STA parks on a NPCA primary channel and the other secondary channels such that the parked NPCA primary channel and the parked other secondary channels is a 80 MHz channel per the channelization. Like the primary channel, the backoff procedure is also associated with a NPCA primary channel for the frame exchanges in the NPCA primary channel and the other secondary channels. If the primary channel is busy, the wireless device then switches to the NPCA primary channel. In order to transmit the frame(s) of the AC, the backoff counter for the AC in the NPCA primary channel is started based on the announced EDCA parameters. The backoff counter of the AC for the NPCA primary channel is counted down over time if the NPCA primary channel is idle. When a counter value of the backoff counter reaches a predefined value, the wireless device transmits the frame in the NPCA primary channel and the other secondary channels that are idle. The usage of the NPCA primary channel for the frame exchanges may not end until the primary channel is idle again.

In one or more examples, each STA may use a primary channel in the BSS operating channel and if the primary channel is busy for a period longer than a threshold the STA use a NPCA primary channel of the secondary channels for the frame exchanges after the backoff counter becomes 0 in the NPCA primary channel. The primary channel may be in a primary subchannel, and one primary subchannel and the non-primary subchannel(s) may include the secondary channels. Further, in some examples, each non-primary subchannel may have a respective backoff channel.

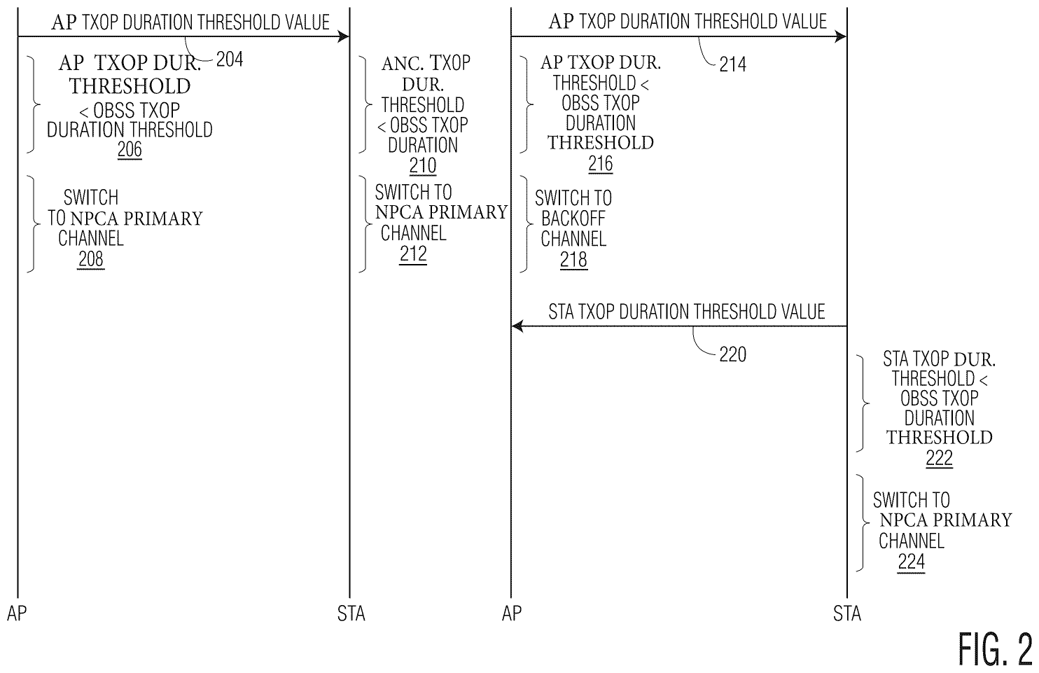

FIG. 2 illustrates various conditions during which the AP and STA switches to the NPCA primary channel in accordance with one or more embodiments. AP and STA may be in a same BSS. The switch may be further based on an OBSS activity in addition to the primary channel being busy. In one or more examples, an AP announces a TXOP duration threshold value at 204. The announcement may be in a management frame in one or more examples such as a beacon frame or probe response frame. A determination is made that the BSS TXOP duration threshold value is less than an OBSS TXOP duration at 206 indicated by an announcement by an AP of the OBSS. In other examples, the determination is made that a PPDU of the OBSS is greater than a length threshold. At 208, the AP switches to a NPCA primary channel to perform the frame exchanges until the end the OBSS TXOP. In one or more examples, all the APs of a multiple BSSID set (or a co-hosted AP set) announce the same TXOP Duration Threshold value where if the OBSS TXOP duration is not less than the announced TXOP Duration Threshold value, the APs and STAs switch to the NPCA primary channel to try to do the frame exchanges until the end of the OBSS TXOP. Similarly, the STA determines that the TXOP duration threshold value announced by the associated AP is less than an OBSS TXOP duration at 210 indicated by an announcement by an AP of the OBSS. At 212, the STA switches to a NPCA primary channel to perform the frame exchanges until the end of the OBSS TXOP. In some embodiments, the threshold value announced by the AP can also be applied to OBSS PPDU. If the threshold value is less than a detected OBSS PPDU, the AP/STA detecting the PPDU switches to a NPCA primary channel for the frame exchanges until the end of the OBSS PPDU.

In one or more examples, the AP and STA may determine to switch to the NPCA primary channel separately based on a respective TXOP. The AP may announce an AP TXOP duration threshold value at 214. The AP determines that the AP TXOP duration threshold value is less than an OBSS TXOP duration at 216. At 218, the AP switches to a NPCA primary channel to perform the frame exchanges until the end of primary channel's TXOP for the AP. Similarly, the STA may announce a TXOP duration threshold value at 220. The STA determines that the STA TXOP duration threshold value is less than an OBSS TXOP duration at 222. At 224, the STA switches to a NPCA primary channel to perform the frame exchanges until the end of the OBSS TXOP.

In some examples, the STA and the AP may decide whether to perform the frame exchanges in a NPCA primary channel based on a duration of the OBSS's TXOP in a primary channel, a respective TXOP Duration Threshold value of the STA and AP, and a OBSS's TXOP remaining time indicated in a duration field of a MAC header or PHY header of a management frame of the OBSS. In one or more examples, the switch to the NPCA primary channel may be performed if the AP's announced TXOP Duration Threshold value is less than the OBSS TXOP duration and the STA's announced TXOP Duration Threshold value is less than the OBSS TXOP duration.

In some examples, the STA may not switch to a non-primary channel even when the primary channel is busy. For example, the STA may not perform a switch when the STA is in doze state of a power save mode and not configured to be awake to transmit and receive frame in a non-primary channel. As one or more examples, the STA may not perform a switch when the OBSS's TXOP that makes the primary channel busy is within certain time of a broadcast target wakeup time (TWT) service period (SP) where the STA is not the member of the related broadcast TWT schedule. As one or more examples, the STA may not perform a switch when the STA has co-located radio that is operating in the NPCA primary channel during the OBSS's TXOP to which the STA would switch.

The NPCA primary channel is a secondary channel. The AP is able to transmit a frame to an STA if the STA is able to receive a frame on a secondary channel. The capability may depend on various announcements by the STA.

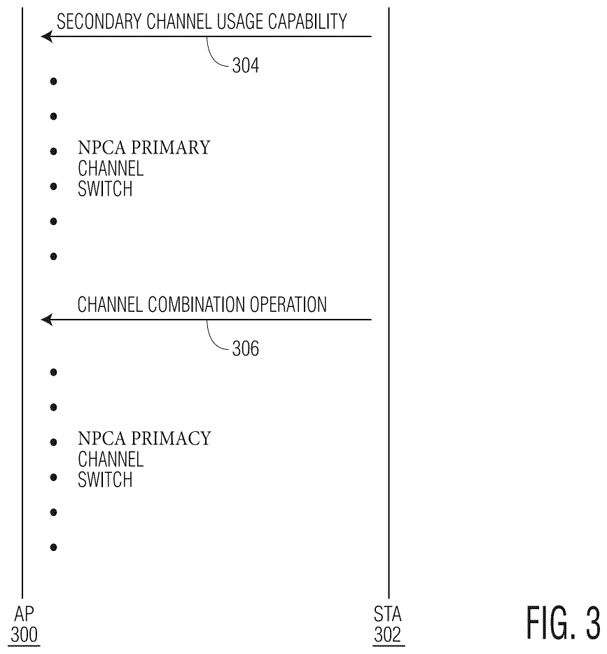

FIG. 3 illustrates example announcements by the STA to use the NPCA primary channel for frame reception in accordance with one or more embodiments. In one or more examples, an STA 302 may announce to an AP 300 at 304 a secondary channel usage capability to exchange frames with the AP. The announcement may be in a management frame in one or more examples. The AP may switch to the NPCA primary channel and transmit frames based on the announcement if a primary channel is busy. In one or more examples, an STA announces that it supports a channel combination operation (starting the physical layer protocol data unit (PPDU) decoding on primary channel and secondary channels simultaneously) capability at 306. The announcement may be in a management frame in one or more examples. An AP that switches to the NPCA primary channel can transmit the frame(s) to a STA that supports the channel combination operation even if the STA does not have to enable secondary channel usage (=switch NPCA primary channel).

The BSS may have a plurality of subchannels each having a NPCA primary channel. The other secondary channels may be combined with the NPCA primary channel in different ways when a backoff counter of a NPCA primary channel becomes zero in one or more examples.

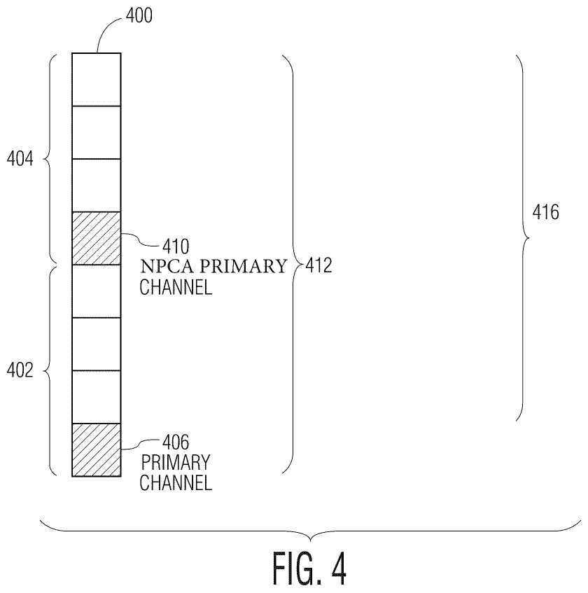

FIG. 4 illustrates various combinations of channel usage in a BSS operating channel in accordance with one or more embodiments. In one or more examples, the BSS operating channel 400 may include two subchannels 402, 404 where one subchannel includes a primary 20 MHz channel and another subchannel includes a NPCA primary channel. In one or more examples, when a backoff counter of a primary channel 406 of the primary subchannel 402 becomes zero, secondary channels of the subchannel 404 and 402 may be combined with the primary channel 406 if the secondary channels of the subchannel 404 and 406 or part of channels of the subchannel 404 and 406 is idle at 412 to transmit frames. In one or more examples, the related secondary channel(s) in the subchannel are idle point coordination interframe space (PIFS) before the transmission. In one or more examples, the STA/AP switches to NPCA primary channel 410 if the primary channel 406 is busy. When a backoff counter of a NPCA primary channel 410 of the non-primary subchannel 404 becomes zero, secondary channels of the subchannel 404 and 402 may be combined with the NPCA primary subchannel 410 if the secondary channels of the subchannel 404 and 402 or part of channels of the subchannel 404 and 402 is idle at 416 to transmit frames. In one or more examples, the related 20 MHz channel(s) in the subchannel are idle point coordination interframe space (PIFS) before the transmission. In some embodiments, the NPCA primary channel 410 and the combined secondary channels satisfy the channel puncture rules with the NPCA primary channel being treated as primary channel. In some embodiments, if the frames in a PPDU transmitted by the TXOP holder include Trigger frame other than MU-RTS, any secondary channels can be combined. If the frames in a PPDU transmitted by the TXOP holder do not include Trigger frame other than MU-RTS, the NPCA primary channel and the combined secondary channels satisfy the punctured non-OFDMA PPDU requirement with NPCA primary channel being treated as primary channel. In some examples, an AP and STA may negotiate a bandwidth to transmit frames after the backoff counter on NPCA primary channel becomes 0. The TXOP holder may transmit a request to transmit (RTS) frame and the TXOP responder may transmit a clear to send (CTS) frame which indicates a bandwidth available for use as part of a dynamic bandwidth negotiation. In some embodiments, the NPCA primary channel and the combined secondary channels used by RTS and CTS satisfy the punctured non-OFDMA PPDU requirement with NPCA primary channel being treated as primary channel. For example, when a backoff counter for an AP for a 20 MHz NPCA primary channel reaches zero, the AP may transmit a request to send (RTS) frame to an STA for dynamic BW negotiation in a 160 MHz non-HT PPDU with primary 40 MHz being punctured. The STA being addressed by the RTS will transmit CTS frame in an 80 MHz PPDU covering the NPCA primary channel in response if the secondary subchannel is idle and the secondary channels in primary subchannel are busy.

Enhanced Distributed Channel Access (EDCA) parameters are used to prioritize wireless channel access on the primary channel for voice, video, and other quality-of-service (QoS) traffic on wireless local area networks (WLANs). EDCA is part of the IEEE 802.11 standard, which defines a contention based process for affecting traffic flowing between the AP and STA. The backoff process for the NPCA primary channel may be performed using EDCA parameters. The EDCA parameters associated with the NPCA primary channel for the AP and STA may be defined to facilitate setting of the counter value of the backoff counter of the NPCA primary channel with a selected value before performing frame exchange.

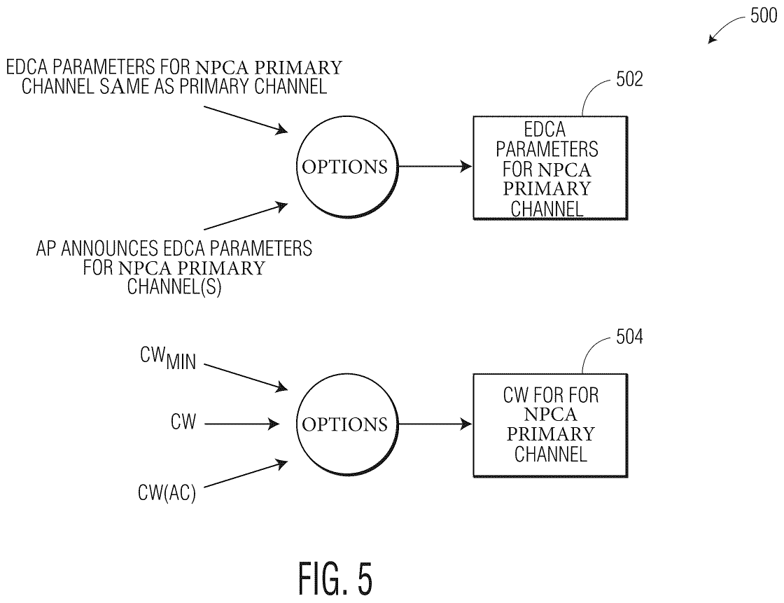

FIG. 5 illustrates various parameters settings 500 of the NPCA primary channel in accordance with one or more embodiments. In one or more examples, options of multi-user (MU) EDCA parameters and EDCA parameters which are used for the backoff in NPCA primary channel and are shown as EDCA parameter set 502 and MU EDCA parameter set 502 which may be same as the corresponding EDCA parameter set and MU EDCA parameter set on the primary channel for the AP and STA. In one or more examples, the EDCA and MU EDCA parameter 502 for the NPCA primary channel may be different from the EDCA and MU EDCA parameter set for the primary channel in which case the AP announces the EDCA and MU EDCA parameter set for the NPCA primary channel separately from the EDCA and MU EDCA parameter set for the primary channel in a beacon frame or probe response frame. In one or more examples, the EDCA parameters and MU EDCA parameters in all the different backoff channels of the different subchannels may be the same. The AP announces the one EDCA Parameter Set element and one MU EDCA Parameter Set element which is then used by the STA for the different backoff channels for the STA. The AP may announce the different EDCA Parameter Set elements and the different MU EDCA Parameter Set element for the different NPCA primary channels.

In some embodiments, the CW of an AC (CW[AC]) for a NPCA primary channel may be set to CWmin of the AC after switch to the NPCA primary channel. In some embodiments, the CW of an AC for a NPCA primary channel may use the CW of AC in the primary channel after switch to the NPCA primary channel. In some embodiments, the AP and STA may each maintain one CW[AC] for each NPCA primary channel. When switching to the NPCA primary channel, the maintained CW[AC] is used instead of setting to CWmin [AC] or using CW[AC] of the primary channel. In one or more examples, the STA and AP may individually decide whether to maintain one CW[AC] for each NPCA primary channel.

The CW may be used to set the counter value of the backoff counter of a backoff channel. In one or more examples, the AP or STA may attempt to use its primary channel for frame exchange. If the primary channel is busy, then a NPCA primary channel is used for the frame exchange. The backoff counter of an AC of the NPCA primary channel is used to decide when the frame exchanges start on the NPCA primary channel. In some embodiments, when a STA or AP switches to a NPCA primary channel from the primary channel and the backoff counter of an AC has non-zero value in the primary channel, the STA or AP may continue a backoff procedure using the current counter value of the backoff counter. The AP/STA may resume EDCA procedures on the NPCA primary channel, provided that the medium condition is not otherwise indicated as BUSY on the NPCA primary channel. In some embodiments, when a STA or AP switches to NPCA primary channel and the backoff counter has a zero value for the NPCA primary channel, the STA or AP may select a random number based on the CW of an AC to set the backoff counter of the AC, and then start the backoff procedure for the AC. In some embodiments, when a STA or AP switches to a NPCA primary channel and needs to do a backoff for an AC, the STA or AP selects the counter value for the AC per the current CW of the AC in the NPCA primary channel. In some embodiments, when a STA/AP switches back to the primary channel from a NPCA primary channel, the CW, backoff counter of an AC resume to the CW and the backoff counter right before switching to the NPCA primary channel. In some embodiments, when a STA/AP switches back to the primary channel from a NPCA primary channel, the CW, backoff counter of an AC in the NPCA primary channel are used for the backoff in the primary channel.

In one or more examples, the EDCA procedure may use a quality of service short retry counter (QSRC). The QSRC of an AC (QSRC[AC]) may indicate a number of failed transmissions of the frames of the AC and is used to decide whether to double the CW or reset the CW to CWmin of the AC based on the comparation of the QSRC and a threshold value. In one or more examples, each time an AP or STA switches to the NPCA primary channel, its QSRC for all ACs are set to 0 for the NPCA primary channel and the failed transmission of a frame having an AC category on the NPCA primary channel is counted by QSRC[AC] which represents the QSRC for a particular AC category. Different AC categories will have a respective QSRC as indicated by this notation. In one or more examples, each time an AP or STA switches to the NPCA primary channel, its QSRC for each AC are set to the respective QSRC for each AC on the primary channel and the failed transmission of a frame having an AC category on the NPCA primary channel is counted by QSRC[AC] which represents the QSRC for a particular AC category. In one or more examples, the STA and AP may maintain one QSRC[AC] for each non-primary channel. In one or more examples, the STA and AP may individually decide whether to maintain one QSRC[AC] for each non-primary channel. In some embodiments, when a STA/AP switches back to the primary channel from a NPCA primary channel, the QSRC of an AC resume to the QSRC of the AC right before switching to the NPCA primary channel. In some embodiments, when a STA/AP switches back to the primary channel from a NPCA primary channel, the QSRC of an AC in the NPCA primary channel are used for the backoff in the primary channel.

The wireless device performs a clear channel assessment (CCA) to decide whether the primary channel and secondary channels idle or busy for the backoff procedure. In one or more examples, the CCA of the of the primary channel is performed to decide whether to count down the backoff counter, stop the backoff counter counting down, stay in the primary channel, or switch to the NPCA primary channel. In one or more examples, the STA or AP is not able to perform the CCA of the NPCA primary channel during the transmission of a PPDU that does not cover the NPCA primary channel. The STA or AP may lose medium synchronization in NPCA primary channel depending on how long the CCA is not able to be performed on a NPCA primary channel. If a STA or AP cannot do the CCA on the primary channel for more than a time of 72 us (MediumSyncThreshold) before switching to the NPCA primary channel, the STA or AP loses the medium synchronization when switching to the NPCA primary channel. Otherwise, the STA or AP does not lose the medium synchronization when switching to the NPCA primary channel.

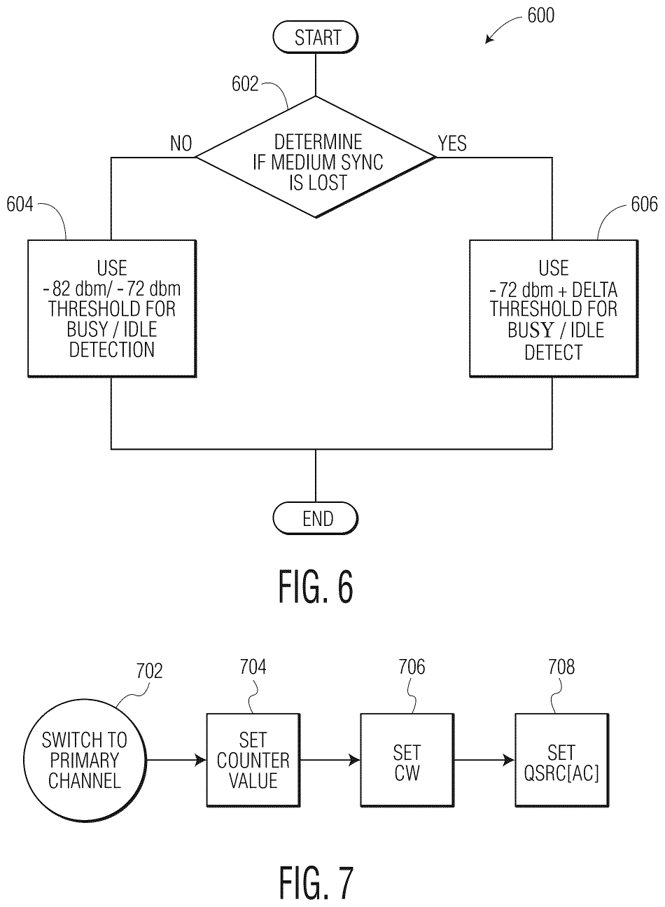

FIG. 6 illustrates example functions 600 for determining the CCA level for whether the NPCA primary channel are busy or idle in accordance with one or more embodiments. The presence or absence of medium synchronization determines what CCA threshold is used to determine whether the NPCA primary channel is busy or idle. At 602, a determination is made whether medium synchronization is lost when switching to the NPCA primary channel. If a STA or AP does not lose the medium synchronization at switch to the NPCA primary channel, at 604, the STA or AP uses −82 dbm as a threshold to decide whether the NPCA primary channel is busy or idle. If power on the medium is less than the threshold then the medium is idle otherwise the medium is busy. Further, the STA or AP uses −72 dbm as a threshold to decide whether a secondary channel other than the NPCA primary channel is busy/idle within PIFS before an initial PPDU transmission, and if the secondary channel is idle, it can be combined with the NPCA primary channel for the initial PPDU transmission under a channel puncture restriction. If a STA or AP loses the medium synchronization of the NPCA primary channel at switch to the NPCA primary channel, at 606, the STA or AP uses −72 dbm+Delta as a threshold to decide whether the anchor channel is busy or idle for the NPCA primary channel where the Delta is announced by the AP. Further, the STA or AP uses −72 dbm+Delta as a threshold to decide whether a secondary channel other than the NPCA primary channel is busy or idle within PIFS before the initial PPDU transmission, and if the secondary channel is idle, it can be combined with the NPCA primary channel for the initial PPDU transmission in presence of any channel puncturing. The −72 dbm+Delta is used for the CCA until MediumSyncTimer that starts after switching to the NPCA primary channel times out. The MediumSyncTimer has initial value of maxPPDULength and starts right after switching to the NPCA primary channel to measure a time associated with transmitting a PPDU.

The initiating PPDU needs to carry a soliciting RTS/MU-RTS/BSRP Trigger and a number of such failed transmissions within a MediumSyncTimer time is not to be more than a threshold announced by the AP. In one or more examples, a network allocation vector (NAV) timer may also be set to indicate a period of time that the medium is busy.

In one or more examples, after switching to a NPCA primary channel, the −72 dbm is used as the CCA level for the backoff on the NPCA primary channel until one frame exchange is successful. The RTS/MU-RTS/BSRP Trigger is used as the first frame of the frame exchange. After one frame exchange is successful, the −82 dbm is used as the CCA level for the following backoff until switching back to the primary channel.

FIG. 7 illustrates various parameter settings 700 when switching from the NPCA primary channel to the primary channel in accordance with one or more embodiments. At 702, a wireless device switches from a NPCA primary channel to a primary channel. In response to the switch, the STA or AP sets the counter value 704 of the backoff counter of the primary channel before starting the backoff counter to determine whether the primary channel is busy or idle. In one or more examples, after switching back to the primary channel, a STA or AP sets a counter value of the backoff timer with a random number selected per a CW of the primary channel before executing the frame exchanges on the primary channel. In one or more examples, before an AP or STA switches to the NPCA primary channel, the counter value of the backoff counter of the NPCA primary channel is kept until switching back to the primary channel. After switching back to the primary channel, a STA or AP resume the count value of the backoff counter by setting the backoff counter 702 with the kept value.

A CW 704 for the primary channel may also be set when switching from the NPCA primary channel back to the primary channel. In one or more examples, the CW being used by the primary channel right before each switch to NPCA primary channel is kept by the STA or AP. After switching back to the primary channel, a STA or AP resumes the CW for the primary channel by the kept value. In one or more examples, the CW 704 to be used by the primary channel after switching from the NPCA primary channel is the CW being used by the NPCA primary channel right after the switching back to the primary channel.

The QSRC[AC] 706 for the primary channel may also be set when switching from the NPCA primary channel back to the primary channel. In one or more examples, the QSRC being used right before switching to the NPCA primary channel is kept by the STA or AP. After switching back to the primary channel, a STA or AP resumes the QSRC[AC] 706 by the kept value. In one or more examples, each time an AP or STA switches back to the primary channel from the NPCA primary channel, the QSRC 706 for all ACs for the primary channel are the same as the QSRC for all ACs on the NPCA primary channel.

During the time switching from the NPCA primary channel to the primary channel, the STA or AP cannot perform the CCA. If the CCA is not able to be performed for the time defined by MediumSyncThreshold (e.g., 72 us) then medium synchronization is lost. Otherwise, the STA/AP does not lose the medium synchronization when switching to the primary channel. In one or more examples, a STA or AP that switches from the NPCA primary channel to the primary channel does not loses the medium synchronization.

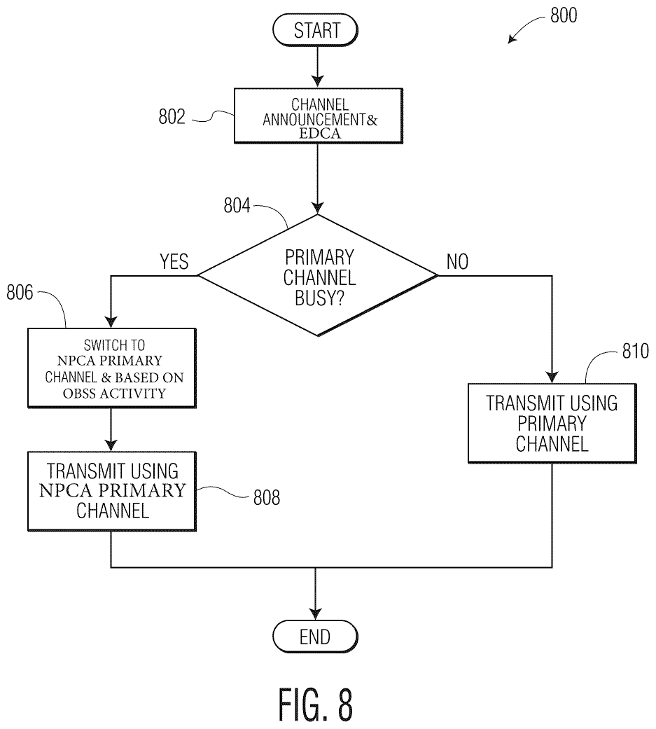

FIG. 8 is an example flow chart of functions 800 associated with switching to the NPCA primary channel when the primary channel is busy in accordance with one or more embodiments. The functions may be performed by a wireless device such as an AP in one or more examples. At 802, an AP announces a NPCA primary channel of a basic service set (BSS) operating channel for frame transmission and EDCA parameters for the NPCA primary channel. The BSS operating channel may include a primary subchannel which includes the primary channel and one or more NPCA primary channels. At 804, a determination by the STA is made whether the primary channel is busy. At 806, the wireless device switches to the NPCA primary channel in response to the primary channel being busy and OBSS activity. The NPCA primary channel may be in non-primary channel of the BSS operating channel. At 808, a frame is transmitted over the NPCA primary channel based on a backoff counter of the NPCA primary channel reaching a predefined value. The CCA and EDCA parameters may be used to set the backoff counter and determine when the frame is transmitted. If the primary channel is not busy, then the primary channel and used to transmit a frame at 810. The wireless device may determine the channel is idle before transmitting the frame. Further, the wireless device may combine one or more secondary channels along with the NPCA primary channel or primary channel to transmit the frame.

In an embodiment, a method is disclosed. The method includes detecting an announcement of one non-primary channel access (NPCA) primary channel of a basic service set (BSS) operating channel for frame transmission; determining that a primary channel is busy; switching to the NPCA primary channel in response to the primary channel being busy, wherein the switching is based on an overlapping BSS (OBSS) activity; and transmitting a frame over the NPCA primary channel when a backoff counter of the NPCA primary channel reaches a predefined value, the backoff counter set based on an enhanced distributed channel access (EDCA) parameter set. In an example, the method includes determining one or more secondary channels of the BSS operating channel is idle; and combining the NPCA primary channel with the one or more secondary channels to transmit the frame. In an example, a backoff procedure in the NPCA primary channel uses the enhanced distributed channel access (EDCA) parameters set which is the same as an EDCA parameters set of the primary channel and a same multi-user (MU) EDCA parameters set as a MU EDCA parameters set of the primary channel. In an example, the method further includes setting a counter value of the backoff counter based on a contention window (CW) of an access category (AC) of the NPCA primary channel when switching to the NPCA primary channel. In an example, the method further includes setting a counter value of the backoff counter based on a minimum contention window (CW) of an access category (AC) of the NPCA primary channel when switching to the NPCA primary channel. In an example, a quality of service short retry counter (QSRC) of the NPCA primary channel for all access categories is set to zero when switching to the NPCA primary channel. In an example, one CW and one QSRC is maintained for each traffic identifier (TID) of the NPCA primary channel. In an example, the method further includes storing a counter value of the backoff counter of the primary channel before switching to the NPCA primary channel; switching back to the primary channel; and setting the backoff counter of the primary channel to the stored counter value. In an example, the method further includes storing a CW of the primary channel before switching to the NPCA primary channel; switching back to the primary channel; and setting a CW of the primary channel to the stored CW. In an example, the method further includes storing a QSRC for an access category of the primary channel before switching to the NPCA primary channel; switching back to the primary channel; and setting the QSRC for the access category of the primary channel to the stored QSRC. In an example, switching to the NPCA primary channel in response to the primary channel being busy includes determining that an overlapping basic service set (BSS) transmit opportunity (TXOP) is not less than a TXOP duration threshold announced by an AP in the BSS. In an example, a same one NPCA primary channel is announced by an AP without multiple BSSID support or all the APs of a multiple basic service set id (BSSID set) or all APs of a co-hosted AP set. In an example, after switching to the NPCA primary channel, a first clear channel assessment (CCA) level is used to determine whether a medium is idle or busy; and when a frame exchange is successful switching to a second CCA level.

In another embodiment, wireless device is disclosed. The wireless device includes circuitry arranged to detect an announcement of one NPCA primary channel of a basic service set (BSS) operating channel for frame transmission; determine that the primary channel is busy; switch to the NPCA primary channel in response to the primary channel being busy wherein the switching is based on an overlapping BSS (OBSS) activity; and transmit a frame over the NPCA primary channel when a backoff counter of the NPCA primary channel reaches a predefined value, the backoff counter set based on an enhanced distributed channel access (EDCA) parameter set. In an example, the wireless device arranged to switch to the NPCA primary channel in response to the primary channel being busy includes the wireless device arranged to determine that an overlapping basic service set (BSS) transmit opportunity (TXOP) is not less than a TXOP duration threshold announced by an AP in the BSS. In an example, after switching to the NPCA primary channel, a first clear channel assessment (CCA) level is used to determine whether a medium is idle or busy; and when a frame exchange is successful switching to a second CCA level. In an example, the wireless device is further arranged to combine the NPCA primary channel whose backoff counter becomes zero with secondary channels for the frame transmission. In an example, the wireless device is further arranged to store a counter value of the backoff counter of the primary channel before switching to the NPCA primary channel; switch back to the primary channel; and set the backoff counter of the primary channel to the stored counter value. In an example, the EDCA parameter set of the NPCA primary channel is the same as the primary channel when switching to the NPCA primary channel, the backoff counter set based on the EDCA parameter set. In an example, a backoff procedure in the NPCA primary channel uses the enhanced distributed channel access (EDCA) parameters set which is the same as an EDCA parameters set of the primary channel and a same multi-user (MU) EDCA parameters set as a MU EDCA parameters set of the primary channel.

A few implementations have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof: including potentially a program operable to cause one or more data processing apparatus such as a processor to perform the operations described (such as program code encoded in a non-transitory computer-readable medium, which can be a memory device, a storage device, a machine-readable storage substrate, or other physical, machine readable medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

Other implementations fall within the scope of the following claims.

What is claimed is:

1. A method comprising:
detecting an announcement of one non-primary channel access (NPCA) primary channel of a basic service set (BSS) operating channel for frame transmission;
determining that a primary channel is busy;
switching to the NPCA primary channel in response to the primary channel being busy, wherein the switching is based on an overlapping BSS (OBSS) activity; and
transmitting a frame over the NPCA primary channel to a wireless device when a backoff counter of the NPCA primary channel reaches a predefined value, the backoff counter set based on an enhanced distributed channel access (EDCA) parameter set.

2. The method of claim 1 further comprising determining one or more secondary channels of the BSS operating channel is idle; and combining the NPCA primary channel with the one or more secondary channels to transmit the frame.

3. The method of claim 1, wherein a backoff procedure in the NPCA primary channel uses the enhanced distributed channel access (EDCA) parameters set which is the same as an EDCA parameters set of the primary channel and a same multi-user (MU) EDCA parameters set as a MU EDCA parameters set of the primary channel.

4. The method of claim 1, further comprising setting a counter value of the backoff counter based on a contention window (CW) of an access category (AC) of the NPCA primary channel when switching to the NPCA primary channel.

5. The method of claim 1, further comprising setting a counter value of the backoff counter based on a minimum contention window (CW) of an access category (AC) of the NPCA primary channel when switching to the NPCA primary channel.

6. The method of claim 1, wherein a quality of service short retry counter (QSRC) of the NPCA primary channel for all access categories is set to zero when switching to the NPCA primary channel.

7. The method of claim 1, wherein one CW and one QSRC is maintained for each traffic identifier (TID) of the NPCA primary channel.

8. The method of claim 1, further comprising storing a counter value of the backoff counter of the primary channel before switching to the NPCA primary channel; switching back to the primary channel; and setting the backoff counter of the primary channel to the stored counter value.

9. The method of claim 1, further comprising storing a CW of the primary channel before switching to the NPCA primary channel; switching back to the primary channel; and setting a CW of the primary channel to the stored CW.

10. The method of claim 1, further comprising storing a QSRC for an access category of the primary channel before switching to the NPCA primary channel; switching back to the primary channel; and setting the QSRC for the access category of the primary channel to the stored QSRC.

11. The method of claim 1, wherein switching to the NPCA primary channel in response to the primary channel being busy comprises determining that an overlapping basic service set (BSS) transmit opportunity (TXOP) is not less than a TXOP duration threshold announced by an AP in the BSS.

12. The method of claim 1, wherein a same one NPCA primary channel is announced by an AP without multiple BSSID support or all the APs of a multiple basic service set id (BSSID set) or all APs of a co-hosted AP set.

13. The method of claim 1, wherein after switching to the NPCA primary channel, a first clear channel assessment (CCA) level is used to determine whether a medium is idle or busy; and when a frame exchange is successful switching to a second CCA level.

14. A wireless device comprising circuitry arranged to detect an announcement of one NPCA primary channel of a basic service set (BSS) operating channel for frame transmission; determine that the primary channel is busy; switch to the NPCA primary channel in response to the primary channel being busy wherein the switching is based on an overlapping BSS (OBSS) activity; and transmit a frame over the NPCA primary channel when a backoff counter of the NPCA primary channel reaches a predefined value, the backoff counter set based on an enhanced distributed channel access (EDCA) parameter set.

15. The wireless device of claim 14, wherein the wireless device arranged to switch to the NPCA primary channel in response to the primary channel being busy comprises the wireless device arranged to determine that an overlapping basic service set (BSS) transmit opportunity (TXOP) is not less than a TXOP duration threshold announced by an AP in the BSS.

16. The wireless device of claim 14, wherein after switching to the NPCA primary channel, a first clear channel assessment (CCA) level is used to determine whether a medium is idle or busy; and when a frame exchange is successful switching to a second CCA level.

17. The wireless device of claim 14, wherein the wireless device is further arranged to combine the NPCA primary channel whose backoff counter becomes zero with secondary channels for the frame transmission.

18. The wireless device of claim 14, wherein the wireless device is further arranged to store a counter value of the backoff counter of the primary channel before switching to the NPCA primary channel; switch back to the primary channel; and set the backoff counter of the primary channel to the stored counter value.

19. The wireless device of claim 14, wherein the EDCA parameter set of the NPCA primary channel is the same as the primary channel when switching to the NPCA primary channel, the backoff counter set based on the EDCA parameter set.

20. The wireless device of claim 14, wherein a backoff procedure in the NPCA primary channel uses the enhanced distributed channel access (EDCA) parameters set which is the same as an EDCA parameters set of the primary channel and a same multi-user (MU) EDCA parameters set as a MU EDCA parameters set of the primary channel.
